(19) United States
(12) Patent Application Publication
(10) Pub. No.: US 2021/0146350 A1
(43) Pub. Date: May 20, 2021

(54) DEVICE FOR GENERATING A DROPLET ARRAY, PREPARATION METHOD AND USE THEREOF

(71) Applicant: SHENZHEN INSTITUTES OF ADVANCED TECHNOLOGY, Shenzhen, Guangdong (CN)

(72) Inventors: Zhiting PENG, Shenzhen, Guangdong (CN); Tianzhun WU, Shenzhen, Guangdong (CN)

(21) Appl. No.: 16/973,702

(22) PCT Filed: Dec. 17, 2018
(86) PCT No.: PCT/CN2018/121393

§ 371 Date: Dec. 9, 2020

(51) Int. Cl. B01L 3/02; B01J 19/00

(52) U.S. Cl. CPC B01L 3/0241; B01J 19/0046; B01L 2200/0689; B01J 2219/00369; B01L 2400/0406; B01J 2219/0036

(57) ABSTRACT

A device for generating a droplet array, which comprises a substrate, a roller on the substrate, and a microgrooved chip on the outer surface of the roller, wherein a sealant is on a surface of the substrate close to the roller and the microgrooved chip comprises a chip body fitted to the roller and an array of microgrooves arranged on the chip body, the array of microgrooves consisting of a plurality of microgrooves arranged at intervals on the chip body. When the roller rolls, liquid between the substrate and the roller enters the microgrooves and forms droplets while the microgrooved chip detaches from the roller and combines with the sealant which seals the microgrooves, generating a droplet array. The device generates a droplet array having uniform droplet size, good repeatability. Further, the method is simple and highly efficient, and has broad application prospects in the fields of medicine and biology.

### RELATED APPLICATION

The present application is a National Phase of International Application No. PCT/CN2018/121393, filed Dec. 17, 2018.

### FIELD OF THE INVENTION

The invention relates to the technical field of microfluidic chips, in particular to device for generating a droplet array, preparation method and use thereof.

### BACKGROUND OF THE INVENTION

At present, droplets capture technique is widely used in research fields such as medical diagnostics, pharmaceuticals, and biology, for instance, digital PCR technology. However, microfluidic chips based on microchannels of syringe pumps have a low capture rate. Furthermore, a large number of mechanical pumps and attachments are required to treat liquid.

The great viscosity resistance generated by the microfluidics during the flow makes it difficult for the mechanical pump to drive the fluid in the elongated pipe. The mechanical micropump destroys or denatures biomolecules in the fluid when processing liquids. In addition, the mechanical pump includes micro-controllable components, which is expensive.

Microfluidics may be readily affected by air bubbles in microfluidic pipes, making it difficult to control the hydraulic pressure in mechanical pumps.

Capturing by microchannels of syringe requires a large syringe pump and auxiliary programs to process the liquids, and such chemical modification process is irreversible and complicated. Further, the droplets produced are of poor uniformity.

Therefore, a traditional microfluidic chip has problems such as low efficiency in generating droplets, difficulty in controlling the droplet size, and uneven size.

### SUMMARY OF THE INVENTION

In view of this, the present invention provides a device for generating a droplet array. The microgrooves are brought into contact with liquid by rolling the roller, thereby producing a shear force which acts on the liquid and then forms droplets into the microgrooves; meanwhile, the microgrooved chip detaches from the roller and combines with the sealant, and the sealant seals the microgrooves, thereby forming a droplet array. The device generates a droplet array having uniform droplet size, good repeatability. Further, the method is simple and highly efficient, and has broad application prospects in the fields of medicine and biology.

In a first aspect, a device for generating a droplet array is proposed. The device comprises a substrate, a roller arranged on the substrate, and a microgrooved chip arranged on the outer surface of the roller, wherein

a sealant is provided on a surface of the substrate close to the roller and the microgrooved chip comprises a chip body fitted to the roller and an array of microgrooves arranged on the chip body, the array of microgrooves consisting of a plurality of microgrooves arranged at intervals on the chip body, and wherein

when the roller rolls, liquid between the substrate and the roller enters the microgrooves and forms droplets while the microgrooved chip detaches from the roller and combines with the sealant which seals the microgrooves, thereby generating a droplet array.

In the present invention, when the microgrooves contact the liquid, a shear force acting on the liquid is produced at openings of the microgrooves, thereby forming a drop of liquid into the microgrooves; meanwhile, the microgrooved chip detaches from the roller and combines with the sealant, and the sealant seals the microgrooves containing a drop of liquid, thereby forming a droplet array.

Alternatively, the cross-sectional shape of the microgroove is semi-elliptical, triangular or quadrilateral. Further, the cross-sectional shape of the microgroove is semi-elliptical.

Alternatively, the longitudinal sectional shape of the microgroove is triangular or quadrilateral. Further, the longitudinal sectional shape of the microgroove is parallelogram. In the present invention, the parallelogram comprises square, rectangle and general parallelogram. Furthermore, the microgrooves are inclined grooves. That is, a side wall of the microgrooves is obliquely arranged within the chip body. In other words, the angle between the longitudinal section of the microgrooves and the chip body is an acute angle, and the microgrooves have a general parallelogram shape in longitudinal section.

In one embodiment where the cross-sectional shape of the microgroove is semi-elliptical and the microgroove is inclined groove, a shear force acting on the liquid is more readily produced, thereby forming droplets into the microgroove. Further, the inclined groove is less likely to generate bubbles and dead zone than the vertical groove. This arrangement takes advantage of three-dimensional surface energy gradient and Laplace pressure difference to achieve the spontaneous flow of the liquid, so that the liquid fills the microgroove under the action of the capillary force. There is no need for a complicated mechanical syringe pump device. The process is simple and highly repeatable. Further, the acute angle of the parallelogram is 45°.

Alternatively, the relationship between oblique angle of the inclined grooves and the droplets satisfies:

α≤180°−2θ,

where θ is the Young's contact angle the droplets create.

In the present invention, the oblique angle of the inclined grooves is not larger than twice the supplementary angle to the Young's contact angle the droplets create.

In the present invention, the oblique angle of the inclined grooves is the acute angle of the parallelogram of the longitudinal section of the microgrooves.

Alternatively, a length of a semi-major axis of the cross section of the microgrooves is in a range of 6 μm-12 μm, and a length of a semi-minor axis of the cross section of the microgrooves is in a range of 1.5 μm-5 μm.

In the present invention, the sealant is cured by irradiation, chemical reaction and others. Alternatively, the sealant is a photocurable adhesive, and the device for generating a droplet array further comprises a light source for irradiating and curing the sealant to seal the microgrooves.

Alternatively, the device for generating a droplet array further comprises a driver coupled to the roller for driving the roller to roll.

The first aspect of the present invention provides a device for generating a droplet array. The microgrooves are brought into contact with liquid by rolling the roller, thereby producing a shear force which acts on the liquid and then forms droplets into the microgrooves; meanwhile, the microgrooved chip detaches from the roller and combines with the sealant, and the sealant seals the microgrooves, thereby forming a droplet array. The device generates a droplet array having uniform droplet size, good repeatability. Further, the method is simple and highly efficient.

In a second aspect, the present invention provides a method for preparing a device for generating a droplet array according to the first aspect, comprising:

providing a microgrooved chip template, followed by pouring molding material of a microgrooved chip onto the microgrooved chip template, and then peeling off the microgrooved chip template after a curing treatment to obtain a microgrooved chip;

providing a roller, fitting the microgrooved chip to the outer surface of the roller;

providing a substrate having a sealant arranged on the surface thereof, the roller being arranged on the surface of the substrate to obtain the device for generating a droplet array.

Alternatively, a method for preparing the microgrooved chip template comprises:

providing a matrix,

performing sequentially plasma treatment, coating, prebaking, exposure, postbaking, development, and cleaning treatments on the matrix to obtain the microgrooved chip template.

Further, the step of performing sequentially plasma treatment, coating, prebaking, exposure, postbaking, development, and cleaning treatments on the matrix comprises:

performing plasma treatment on the matrix,

dispensing a photoresist to a surface of the plasma-treated matrix and spin coating the matrix to obtain a photoresist-coated matrix having a predetermined thickness,

prebaking the photoresist-coated matrix,

adjusting an angle between the prebaked photoresist-coated matrix and a light source to a predetermined angle and exposing the photoresist-coated matrix to light,

postbaking the photoresist-coated matrix obtained after the exposure procedure,

performing a development procedure by immersing in a developer the photoresist-coated matrix obtained after the postbaking procedure,

cleaning the photoresist-coated matrix obtained after the development procedure to obtain the microgrooved chip template.

Alternatively, the exposure procedure is a tilt-exposure process.

Alternatively, the microgrooved chip is fitted to the outer surface of the roller by electrostatic force.

The second aspect of the present invention provides a method for preparing a device for generating a droplet array. The method is simple and low-cost, and is suitable for large-scale preparation of the device for generating a droplet array. By adjusting size of the array of microgrooves of the microgrooved chip during the preparation process, the size of the droplets as formed is controllable, which is beneficial to the application of the device.

In a third aspect, the present invention provides uses of the device for generating a droplet array according to the first aspect in biopharmaceutical technology.

Alternatively, the device for generating a droplet array may be used in digital PCR. Specifically, a method of use comprises, but not limited to, providing a PCR reagent including gene fragments and reagents required for PCR, placing the PCR reagent between the roller and the substrate, rolling the roller so that the PCR reagent enters the microgrooves and is sealed by a sealant to obtain a droplet array; separating the microgrooved chip from the flexible substrate and placing the microgrooved chip in a PCR amplifier, performing fluorescence detection, and calculating the initial copy number or concentration of the gene fragment according to Poisson distribution principle and the number and ratio of positive drops.

The invention provides the following advantages. The invention provides a device for generating a droplet array. A chip body fits to the outer surface of a roller, and the roller is arranged on the surface of the substrate and rolls over the substrate. when the roller rolls, liquid between the substrate and the roller enters the microgrooves and forms droplets while the microgrooved chip detaches from the roller and combines with the sealant which seals the microgrooves, thereby generating a droplet array. The device generates a droplet array having uniform droplet size, good repeatability. Further, the method is simple and highly efficient. The present invention further provides a method for preparing a device for generating a droplet array. The method is simple and low-cost, and is beneficial to the application of the device in the field of biological medicine.

### BRIEF DESCRIPTION OF THE DRAWINGS

To illustrate the present invention or the prior art more clearly, the following briefly introduces the accompanying drawings for describing the implementations or the prior art.

FIG. 1 shows structure of a device for generating a droplet array in accordance with an implementation of the present invention.

FIG. 2 is a top view of a microgrooved chip in accordance with an implementation of the present invention.

FIG. 3 is an enlarged view of the area in the dashed frame in FIG. 1.

FIG. 4 shows the principle of preparing a droplet array by the device for generating a droplet array in accordance with an implementation of the present invention.

FIG. 5 is a scan diagram of a drop of liquid prepared in Example 1, Scale bar denotes 800 μm in FIG. 5(a), and 250 μm in FIG. 5(b).

FIG. 6 shows results of a flow field simulation of Comparative Example 1, FIG. 6(a) for a cylindrical microgroove, and FIG. 6(b) for an inclined microgroove having a semi-elliptical opening.

### DETAILED DESCRIPTION OF ILLUSTRATED EMBODIMENTS

The following clearly describes the present invention with reference to the accompanying drawings. Apparently, the described implementations are merely a part rather than all of the implementations of the present invention. All other implementations obtained by a person of ordinary skill in the art based on the implementations of the present invention without creative efforts shall fall within the protection scope of the present invention.

The invention provides a device for generating a droplet array, which comprises a substrate, a roller arranged on the substrate, and a microgrooved chip arranged on the outer surface of the roller, wherein a sealant is provided on a surface of the substrate close to the roller and the microgrooved chip comprises a chip body fitted to the roller and an array of microgrooves arranged on the chip body, the array of microgrooves consisting of a plurality of microgrooves arranged at intervals on the chip body, and wherein when the roller rolls, liquid between the substrate and the roller enters the microgrooves and forms droplets while the microgrooved chip detaches from the roller and combines with the sealant which seals the microgrooves, thereby generating a droplet array.

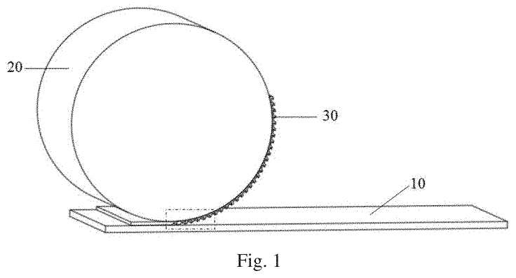

Referring to FIG. 1, FIG. 1 shows structure of a device for generating a droplet array in accordance with an implementation of the present invention. The device for generating a droplet array comprises a substrate 10, a roller 20 arranged on the substrate, and a microgrooved chip 30 arranged on the outer surface of the roller 20, wherein a sealant is provided on a surface of the substrate 10 close to the roller 20 and the microgrooved chip 30 comprises a chip body 31 fitted to the roller and an array of microgrooves arranged on the chip body, the array of microgrooves consisting of a plurality of microgrooves 32 arranged at intervals on the chip body, and wherein when the roller 20 rolls, liquid between the substrate 10 and the roller 20 enters the microgrooves 32 and forms droplets while the microgrooved chip 30 detaches from the roller 20 and combines with the sealant which seals the microgrooves 32, thereby generating a droplet array.

In the present invention, when the microgrooves 32 contact the liquid, openings of the microgrooves 32 will produce a shear force acting on the liquid, thereby forming a drop of liquid into the microgrooves; meanwhile, the microgrooved chip detaches from the roller 20 and combines with the sealant, and the sealant seals the microgrooves 32 containing a drop of liquid, thereby forming a droplet array.

In the present invention, the microgrooves in the array are of the same size, shape of opening, oblique angle and direction.

In an implementation of the present invention, the cross-sectional shape of the microgroove 32 is semi-elliptical, triangular or quadrilateral. Further, the cross-sectional shape of the microgroove 32 is semi-elliptical.

In an implementation of the present invention, the longitudinal sectional shape of the microgroove 32 is triangular or quadrilateral. Further, the longitudinal sectional shape of the microgroove 32 is parallelogram. In the present invention, the parallelogram comprises square, rectangle and general parallelogram. Furthermore, the microgrooves 32 are inclined grooves. That is, a side wall of the microgrooves 32 is obliquely arranged within the chip body. In other words, the angle between the longitudinal section of the microgrooves 32 and the chip body 31 is an acute angle, and the microgrooves 32 have a general parallelogram shape in longitudinal section.

Referring to FIG. 2, FIG. 2 is a top view of a microgrooved chip in accordance with the present invention, wherein the cross-sectional shape of the microgroove 32 is semi-elliptical, and the longitudinal sectional shape of the microgroove 32 is parallelogram.

In the embodiment where the cross-sectional shape of the microgroove 32 is semi-elliptical and the microgroove is inclined groove, a shear force acting on the liquid is more readily produced, thereby forming droplets into the microgroove 32. Further, the inclined groove is less likely to generate bubbles and dead zone than the vertical groove. This arrangement takes advantage of three-dimensional surface energy gradient and Laplace pressure difference to achieve the spontaneous flow of the liquid, so that the liquid fills the microgroove 32 under the action of the capillary force. There is no need for a complicated mechanical syringe pump device. The process is simple and highly repeatable. Further, the acute angle of the parallelogram is 45°.

In an implementation of the present invention, the relationship between oblique angle of the inclined grooves and the droplets satisfies:

α≤180°−2θ,

where θ is the Young's contact angle the droplets create.

In the present invention, the oblique angle of the inclined grooves is not larger than twice the supplementary angle to the Young's contact angle the droplets create.

In the present invention, the oblique angle of the inclined grooves is the acute angle of the parallelogram of the longitudinal section of the microgrooves 32. Specifically, the oblique angle of the inclined grooves may be, but not limited to, 45°.

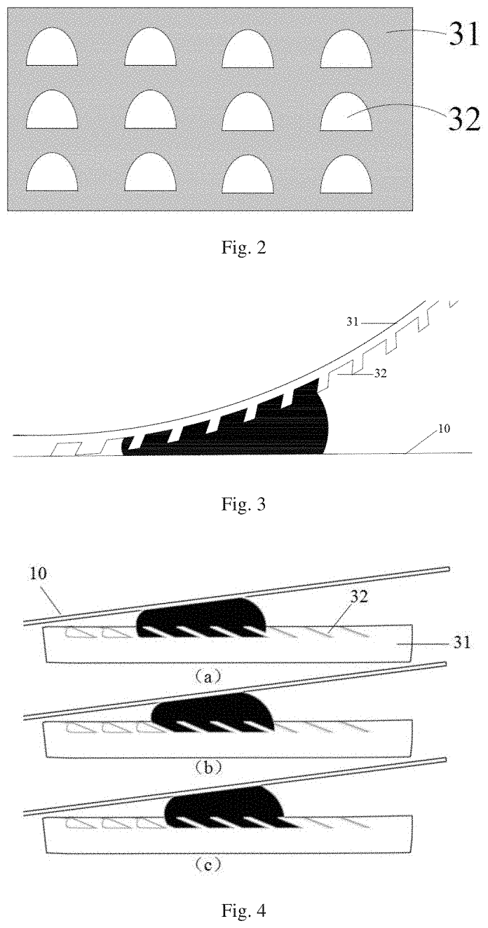

Referring to FIG. 3, FIG. 3 is an enlarged view of the area in the dashed frame in FIG. 1. The longitudinal section of the microgroove 32 is a parallelogram, and the microgroove 32 is an inclined groove, which is more conducive to the generation of shear force between the microgroove and the liquid. This arrangement takes advantage of three-dimensional surface energy gradient and Laplace pressure difference to achieve the spontaneous flow of the liquid, so that the liquid fills the microgroove under the action of the capillary force, and it is less likely to generate bubbles and dead zone.

In an implementation of the present invention, the lateral dimension of the microgrooves 32 is not greater than 15 μm, and the longitudinal dimension is not greater than 15 μm.

In an implementation of the present invention, when the microgrooves 32 have a semi-elliptical shape in cross section, a length of a semi-major axis of the cross section of the microgrooves 32 is in a range of 6 μm-12 μm, and a length of a semi-minor axis of the cross section of the microgrooves 32 is in a range of 1.5 μm-5 μm. Specifically, a length of the semi-major axis may be, but not limited to, 8.5 μm, and a length of the semi-minor axis may be, but not limited to, 3.5 μm.

In an implementation of the present invention, a distance between the microgrooves 32 is in a range of 3 μm-8 μm. In the array of microgrooves, the distance between the microgrooves 32 in each row may be equal to or different from the distance between the microgrooves 32 in each column. Specifically, the distance between the microgrooves 32 in each row is 8 μm, and the distance between the microgrooves 32 in each column is 5 μm.

Referring to FIG. 4, FIG. 4 shows the principle of preparing a droplet array by the device for generating a droplet array in accordance with an implementation of the present invention. The contact position of the droplet and the microgrooved chip during the rolling of the roller changes as shown in FIG. 4 from (a) to (b) and then to (c). In this process, a liquid bridge is formed between the microgrooved chip and the sealant. Due to the minimum restriction (defined as cf, the ratio of the distance from the farthest contact point of the liquid bridge to the tip to the distance from the closest contact point of the liquid bridge to the tip), the liquid bridge tends to move towards the tip through the pinning/unpinning mechanism of the contact line. During rolling, the liquid bridge is compressed, so that the distance between the upper and lower contact surfaces becomes smaller, causing the cf value to increase. When the maximum critical cf value is reached, the liquid bridge moves away from the tip by the surface energy gradient. During the translational movement of the liquid, its interface is cut off by the sharp edges of the microgrooves, and the microgrooves are designed to generate Laplace pressure to separate the liquid directionally to form a single drop. Due to the three-dimensional surface energy gradient, the droplets are locked in the microgrooves. The three-dimensional surface energy gradient and Laplace pressure are the main driving forces for the droplets to enter the microcavity, which makes it possible to produce liquid without relying on a liquid flow.

In an implementation of the present invention, the sealant is a transparent sealant.

In the present invention, the sealant is cured by irradiation, chemical reaction and others. In an implementation of the present invention, the sealant is a photocurable adhesive, and the device for generating a droplet array further comprises a light source for irradiating and curing the sealant to seal the microgrooves 32.

In an implementation of the present invention, the device for generating a droplet array further comprises a driver coupled to the roller 20 for driving the roller 20 to roll.

The microgrooves are brought into contact with liquid by rolling the roller, thereby producing a shear force which acts on the liquid and then forms droplets into the microgrooves; meanwhile, the microgrooved chip detaches from the roller and combines with the sealant, and the sealant seals the microgrooves, thereby forming a droplet array. The device generates a droplet array having uniform droplet size, good repeatability. Further, the method is simple and highly efficient.

The invention also provides a method for preparing the device for generating a droplet array, comprising:

providing a microgrooved chip template, followed by pouring molding material of a microgrooved chip onto the microgrooved chip template, and then peeling off the microgrooved chip template after a curing treatment to obtain a microgrooved chip;

providing a roller, fitting the microgrooved chip to the outer surface of the roller;

providing a substrate having a sealant arranged on the surface thereof, the roller being arranged on the surface of the substrate to obtain the device for generating a droplet array.

In an implementation of the present invention, a method for preparing the microgrooved chip template comprises:

providing a matrix,

performing sequentially plasma treatment, coating, prebaking, exposure, postbaking, development, and cleaning treatments on the matrix to obtain the microgrooved chip template.

In an implementation of the present invention, the step of performing sequentially plasma treatment, coating, prebaking, exposure, postbaking, development, and cleaning treatments on the matrix comprises:

performing plasma treatment on the matrix,

dispensing a photoresist to a surface of the plasma-treated matrix and spin coating the matrix to obtain a photoresist-coated matrix having a predetermined thickness,

prebaking the photoresist-coated matrix,

adjusting an angle between the prebaked photoresist-coated matrix and a light source to a predetermined angle and exposing the photoresist-coated matrix to light,

postbaking the photoresist-coated matrix obtained after the exposure procedure,

performing a development procedure by immersing in a developer the photoresist-coated matrix obtained after the postbaking procedure,

cleaning the photoresist-coated matrix obtained after the development procedure to obtain the microgrooved chip template.

In an implementation of the present invention, the microgrooved chip is fitted to the outer surface of the roller by electrostatic force.

In an implementation of the present invention, a method for preparing the device for generating a droplet array comprises:

providing a substrate, and performing sequentially plasma treatment, coating, prebaking, tilt-exposure, postbaking, development, and cleaning treatments on the matrix to obtain the microgrooved chip template;

pouring polydimethylsiloxane onto the microgrooved chip template, and then peeling off the microgrooved chip template after the polydimethylsiloxane being subjected to a curing treatment to obtain a microgrooved chip;

providing a roller, fitting the microgrooved chip to the outer surface of the roller;

providing a substrate having a sealant arranged on the surface thereof, the roller being arranged on the surface of the substrate to obtain the device for generating a droplet array.

The method provided herein is simple and low-cost, and is suitable for large-scale preparation of the device for generating a droplet array. By adjusting size of the array of microgrooves of the microgrooved chip during the preparation process, the size of the droplets as formed is controllable, which is beneficial to the application of the device.

The invention provides uses of the device for generating a droplet array in biopharmaceutical technology.

In an implementation of the present invention, the device for generating a droplet array may be used in digital PCR. Specifically, a method of use comprises, but not limited to, providing a PCR reagent including gene fragments and reagents required for PCR, placing the PCR reagent between the roller and the substrate, rolling the roller so that the PCR reagent enters the microgrooves and is sealed by a sealant to obtain a droplet array; separating the microgrooved chip from the flexible substrate and placing the microgrooved chip in a PCR amplifier, performing fluorescence detection, and calculating the initial copy number or concentration of the gene fragment according to Poisson distribution principle and the number and ratio of positive drops.

In the present invention, both the substrate and the roller can be reused. The sealant can be removed from the microgrooved chip by chemical or physical cleaning. The microgrooved chip can also be reused. The preparation process of the microgrooved chip is simple and low-cost, suitable for single use.

### Example 1

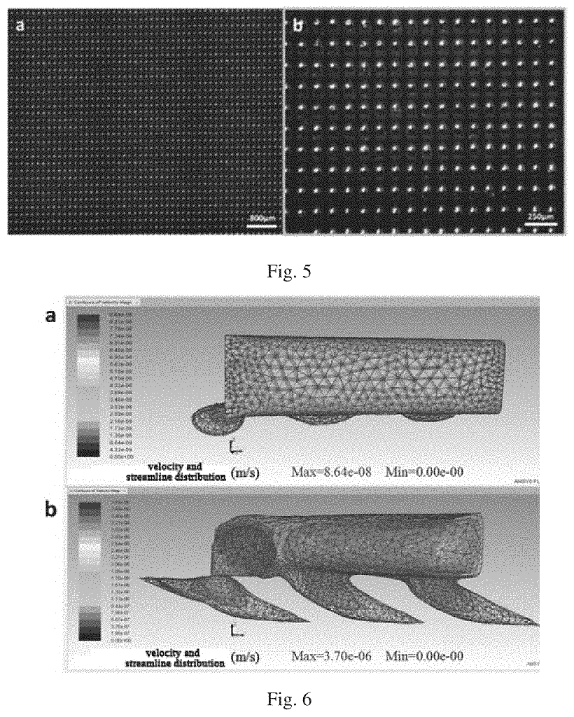

By using the above-mentioned device for generating a droplet array, liquid was placed between the substrate and the roller. The roller rolled such that liquid between the substrate and the roller entered the microgrooves and formed droplets while the microgrooved chip detached from the roller and combined with the sealant which sealed the microgrooves, thereby generating a droplet array. The droplet array was scanned, and the result was shown in FIG. 5. It can be seen that the device for generating a droplet array of the present invention has high efficiency, and a plurality drops can be prepared at the same time. The droplets were subjected to a size test. It was found that the evaluated size of the droplets was 21.78 μm with an extremely small size difference, indicating that the droplets had uniform size.

### Comparative Example 1

The fluid movement was simulated by the flow field simulation software FLUENT, where the microgroove cavity in the array of microgrooves on the microgrooved chip is a cylinder (FIG. 6a) and a semi-elliptical opening (FIG. 6b). That is, the microgroove shown in FIG. 6 (a) has a circular cross-section and a rectangular longitudinal section, and the inclined microgroove shown in FIG. 6 (b) has a semi-elliptical cross-section and a general parallelogram longitudinal section. It can be seen that the inclined microgroove produced a better capillary flow than the vertical structure, and it is readily to force the liquid to flow into the microgroove to obtain a single droplet.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A device for generating a droplet array, the device comprising a substrate, a roller arranged on the substrate, and a microgrooved chip arranged on the outer surface of the roller, wherein
a sealant is provided on a surface of the substrate close to the roller and the microgrooved chip comprises a chip body fitted to the roller and an array of microgrooves arranged on the chip body, the array of microgrooves consisting of a plurality of microgrooves arranged at intervals on the chip body, and wherein
when the roller rolls, liquid between the substrate and the roller enters the microgrooves and forms droplets while the microgrooved chip detaches from the roller and combines with the sealant which seals the microgrooves, thereby generating a droplet array.

2. The device for generating a droplet array of claim 1, wherein the cross-sectional shape of the microgroove is semi-elliptical, triangular or quadrilateral, and the longitudinal sectional shape of the microgroove is triangular or quadrilateral.

3. The device for generating a droplet array of claim 2, wherein the cross-sectional shape of the microgroove is semi-elliptical, and the longitudinal sectional shape of the microgroove is parallelogram.

4. The device for generating a droplet array of claim 3, wherein the microgrooves are inclined grooves.

5. The device for generating a droplet array of claim 4, wherein the relationship between oblique angle of the inclined grooves and the droplets satisfies:
α≤180°−2θ,
where θ is the Young's contact angle the droplets create.

6. The device for generating a droplet array of claim 3, wherein a length of a semi-major axis of the cross section of the microgrooves is in a range of 6 μm-12 μm, and a length of a semi-minor axis of the cross section of the microgrooves is in a range of 1.5 μm-5 μm.

7. The device for generating a droplet array of claim 1, wherein the sealant is a photocurable adhesive, and the device for generating droplet array further comprises a light source for irradiating and curing the sealant to seal the microgrooves.

8. The device for generating a droplet array of claim 1, further comprising a driver coupled to the roller for driving the roller to roll.

9. A method for preparing a device for generating a droplet array of claim 1, comprising:
providing a microgrooved chip template, followed by pouring molding material of a microgrooved chip onto the microgrooved chip template, and then peeling off the microgrooved chip template after a curing treatment to obtain a microgrooved chip;
providing a roller, fitting the microgrooved chip to the outer surface of the roller;
providing a substrate having a sealant arranged on the surface thereof, the roller being arranged on the surface of the substrate to obtain the device for generating a droplet array.

10. (canceled)
